(19) United States
(12) Patent Application Publication
(10) Pub. No.: US 2009/0040524 A1
(43) Pub. Date: Feb. 12, 2009

(54) Multi-channel biosensor using surface Plasmon resonance

(75) Inventor: Il Kweon Joung, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/078,044

(22) Filed: Mar. 26, 2008

(30) Foreign Application Priority Data
Jun. 29, 2007 (KR) 10-2007-0065787

(51) Int. Cl. G01N 21/55

(52) U.S. Cl. 356/445

(57) ABSTRACT

Provided is a multi-channel biosensor using a biosensor using a surface plasmon resonance capable of measuring the changed resonance angle in real time without additionally scanning an incident angle according to the change of temperature or external environment by including a sensor chip with a plurality of channels arranged on a top surface thereof in parallel, a light source for vertically emitting a beam from a top portion of the sensor chip to a direct bottom portion of the sensor chip, a first lens for defocusing the beam emitted from the light source in the top portion of the sensor chip, a beam splitter for splitting a reflected beam, wherein the reflected beam is obtained by reflecting the beam defocused through the first lens from each channel of the sensor chip and a sensing unit for receiving a parallel component of the beam split in the beam splitter.

### CROSS-REFERENCE TO RELATED APPLICATIONS

This application claims the benefit of Korean Patent Application No. 10-2007-0065787 filed with the Korea Intellectual Property Office on Jun. 29, 2007, the disclosure of which is incorporated herein by reference.

### BACKGROUND OF THE INVENTION

1. Field of the Invention

The present invention relates to a biosensor using a surface plasmon resonance, and, more particularly, to a multi-channel biosensor using a surface plasmon resonance capable of comparatively measuring resonance angles to beams reflected from at least two channels by including a plurality of fluidic channels provided with a reference channel and a measurement channel on a metal thin film and by sensing the reflected light intensity to the beams defocused through the reference channel and the measurement channel in a sensing unit at the same time, thereby offsetting a measurement deviation to a response change of a measured substance without scanning an incident angle and measuring the resonance angles in real time.

2. Description of the Related Art

Generally, a sensor system using a surface plasmon resonance is used for measuring a refractive index, a thickness or a concentration change of medium by absorbing a resonance to incident light of a surface plasmon(a charge density vibration generated from an interface between a metal thin film and a dielectric) existing on a surface of the metal thin film.

At this time, a TM polarized wave as an element perpendicular to the interface between the metal thin film and the dielectric has to be impinged to generate the vibration of the surface plasmon

An SPR (Surface Plasmon Resonance) method as an optical sensing method capable of being applied to a biosensor uses a surface plasmon phenomenon generated from a surface of a metal thin film. That is, when impinging light on the metal thin film with a predetermined thickness, there is generated a surface plasmon resonance phenomenon that the reflected wave disappears with absorbing whole energy of an incident wave into the metal thin film by matching the phase of the incident wave in a direction parallel with an interface at a specific incident angle and a surface plasmon wave moving along an interface between the metal thin film and air.

As described above, an angle at which reflectivity of light absorbed by the metal thin film is reduced rapidly is referred to as a surface plasmon resonance angle (θ_{SP}, SPR angle) and the extent of response of a biomaterial contacted with the surface of the metal thin film by the SPR angle is sensed through the change of a refractive index.

A measurement method using such a SPR angle uses the surface plasmon resonance phenomenon by controlling the incident angle of light impinged on a prism or a diffraction grating mainly and the following prior arts have been suggested.

First of all, a method for changing an incident angle substantially by moving a light source itself or rotating a substrate mainly so as to change the incident angle of the light by a mechanical movement requires much cost for constructing a device as a delicate mechanical and electronic system is needed to control a rotation of the light source or the substrate. Further, the above-mentioned method has a disadvantage in that stability and reliability of the system are degraded and the system has a complex structure as the method uses a dynamic movement of the light source and the substrate for controlling the incident angle.

Further, it has been pointed out that the above-mentioned method has a problem that the SPR angle measured by a reflected light reflected on the metal thin film may be varied by not only an autonomic state change of the biomaterial as a sample but also a changed refractive index of a buffer solution containing the sample, and therefore it is difficult to determine with only the measured resonance angle whether the SPR angle is varied by the autonomic change of the sample or the refractive index change according to an external environment such as an external temperature variation or a concentration variation of the buffer solution.

Accordingly, the conventional device for measuring the resonance angle has a disadvantage to increase a manufacturing cost of the measurement device since a device for controlling a temperature is used to maintain the temperature of the measurement device itself for the resonance angle so as to control the change of the sample by the change of the external environment maximally.

Further, the conventional device for measuring the resonance angle is capable of measuring the resonance angle according to changed incident angles respectively while controlling the incident angle of a beam through a light source, but it has a disadvantage that it is hard to measure the resonance angle exactly to the corresponding incident angle in real time since it is not possible to know a measurement deviation of the resonance angle by the above-described external temperature variation and a wavelength variation of the beam through the light source, or the like.

### SUMMARY OF THE INVENTION

The present invention is to solve all the disadvantages and problems of the biosensor using the conventional surface plasmon resonance and provide a multi-channel biosensor using a surface plasmon resonance capable of knowing a measurement deviation to a response change of a sample as an object to be measured and measuring a changed resonance angle without scanning an incident angle additionally in real time by respectively measuring the resonance angles to a beam irradiated perpendicularly from a light source through a plurality of fluidic channels including a reference channel and a measurement channel installed on a metal thin film provided with a convexoconcave surface.

An object of the present invention can be achieved by providing a multi-channel biosensor using a surface plasmon resonance including a sensor chip including a plurality of channels arranged on a top surface thereof in parallel, a light source for vertically emitting a beam from a top portion of the sensor chip to a direct bottom portion of the sensor chip, a first lens for defocusing the beam emitted from the light source in the top portion of the sensor chip, a beam splitter for splitting a reflected beam, wherein the reflected beam is obtained by reflecting the beam defocused through the first lens from each channel of the sensor chip and a sensing unit for receiving a parallel component of the beam split in the beam splitter.

The multi-channel biosensor using the surface plasmon resonance further includes a second lens for in front of the sensing unit converting the reflected beam of each of the channels which is emitted toward the sensing unit into a parallel light.

The second lens is preferably formed of a collimator lens to convert the beam passing through by being split through the beam splitter into the parallel light.

The channels of the sensor chip are formed of a pair of reference channel and measurement channel and may be formed of a multi-channel including a plurality of reference channels and measurement channels as the case may be.

Meanwhile, the sensor chip is formed in a structure including a substrate and a dielectric layer combined with a top surface thereof and includes a metal thin film on a top surface of which the reference channel and the measurement channel are arranged in parallel at a beam spot on which the beam is impinged with being interposed between the substrate and the dielectric layer.

At this time, the top portion of the metal thin film is preferably formed of a convexoconcave surface.

Further, the reference channel and the measurement channel are formed in a mutually symmetrical structure and a central part thereof where the beam is impinged may be formed in a shape of a triangle, a hemi-circle, a tetragon or a trapezoid to face each other.

The sensing unit is formed in an array type such that the beam reflected from each of channels of the sensor chip including the plurality of channels is received according to each channel.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram showing the construction of a biosensor using a surface plasmon resonance in accordance with the present invention;

FIG. 2 is a perspective view of a sensor chip used in the biosensor in accordance with the present invention;

FIG. 3 is a diagram showing a reference channel and a measurement channel used in the biosensor in accordance with an embodiment of the present invention;

FIG. 4 is a graph illustrating a result of measuring a light intensity when the reference channel and the measurement channel have the same refractive index in the biosensor in accordance with the present invention; and

FIG. 5 is a graph illustrating a result of measuring a light intensity when the reference channel has a refractive index different from that of the measurement channel in the biosensor in accordance with the present invention.

### DETAILED DESCRIPTION OF THE PREFERRED EMBODIMENTS

Hereinafter, a matter regarding to an operation effect including a technical configuration corresponding to the object of the biosensor using the surface plasmon resonance in accordance with the present invention will be appreciated clearly through the following detailed description with reference to the accompanying drawings illustrating preferable embodiments of the present invention.

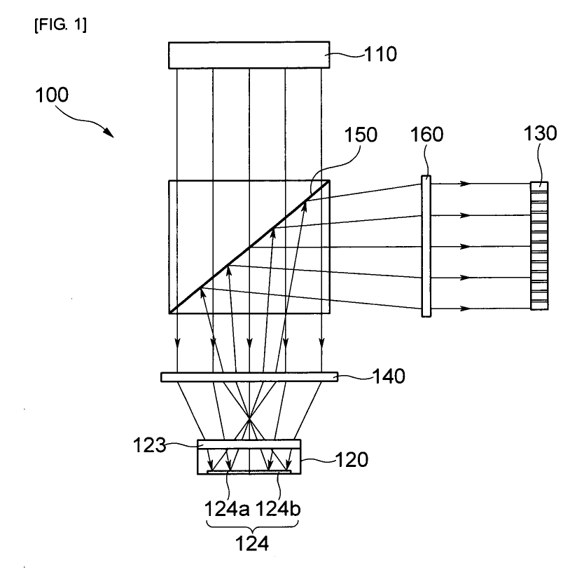

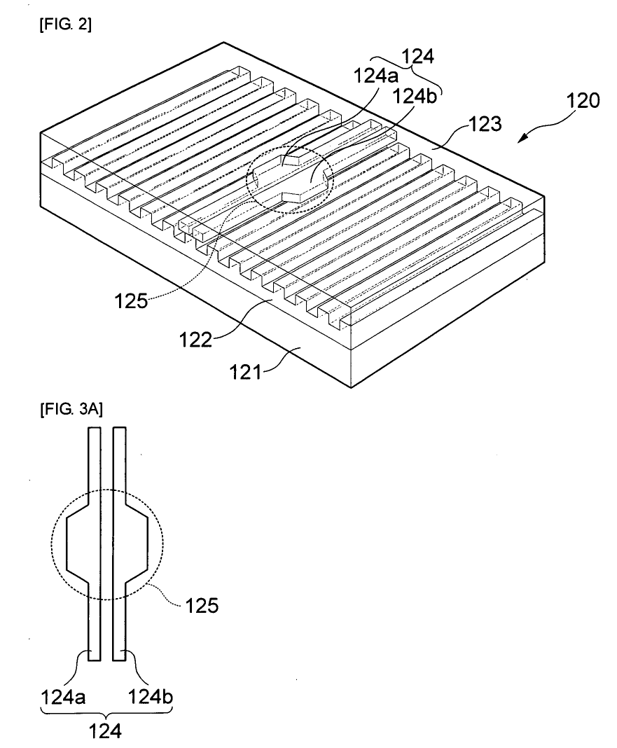

First of all, FIG. 1 is a diagram showing the construction of a biosensor using a surface plasmon resonance in accordance with the present invention, and FIG. 2 is a perspective view of a sensor chip employed in the biosensor in accordance with the present invention.

As shown, the biosensor 100 in accordance with the present invention includes a light source 110, a sensor chip 120 on which a beam emitted from the light source 110 is reflected, and a sensing unit 130 for measuring a light intensity to the beam reflected on the sensor chip 120.

The beam emitted from the light source 110 is received through the sensing unit 130 by irradiating to a direct bottom portion of the light source 110 and totally reflecting through the sensor chip 120 installed in a lower part to be spaced apart from the light source 110 at a predetermined interval.

At this time, the beam emitted from the light source 110 is vertically irradiated toward the sensor chip 120 as a parallel light, and when the beam is received in the sensor chip 120 by being defocused in front of the sensor chip 120, after being defocused, the beam is irradiated with the same incident angle to the sensor chip 120 placed in a direct bottom portion of the light source 110.

A first lens 130 is further included between the light source 110 and the sensor chip 120, the beam emitted from the light source 110 is focused in an upper part adjacent to a top surface of the sensor chip 120 while passing through the first lens 140 and the beam is defocused when being impinged into the sensor chip 120.

When the beam focused in the top portion of the sensor chip 120 is split at a focusing spot to travel toward the sensor chip 120, both sides forms a mutual symmetry with respect to a center part of the sensor chip 120, thereby having the same incident angle.

Herein, the meaning of splitting the beam traveled toward the sensor chip 120 is that the light traveling toward the sensor chip 120 is divided according to intrinsic wavelengths which the light has.

Meanwhile, as shown in FIG. 2, the sensor chip 120 includes a substrate 121; a metal thin film 122 formed on a top surface of the substrate 121; and a dielectric layer 123 of a transparent medium covered on a top portion of the metal thin film 122, wherein a plurality of fluidic channels 124 formed of the reference channel 124a and the measurement channel 124b are interposed between a top surface of the metal thin film 122 and the dielectric layer 123.

It is preferable that the metal thin film 122 adhered closely on the substrate 121 is preferably formed of a convexoconcave surface; and the reference channel 124a and the measurement channel 124b are arranged in a mutually symmetrical structure with a beam spot portion 125 at a center thereof, wherein the beam defocused at an arbitrary spot of a top surface of the convexoconcave surface is reflected at the beam spot portion 125.

The refractive indices of the reference channel 124a and the measurement channel 124b are equal to or different from each other; and the reference channel and the measurement channel are preferably formed of materials having refractive indices different from each other such that a response extent of a sample is distinguished easily through the reference channel 124a and the measurement channel 124b.

Herein, the sensor chip 120 in FIG. 2 is shown for only one reference channel 124a and one measurement channel 124b at a center part of the metal thin film 122 provided with the convexoconcave surface respectively, however, the sensor chip may be also constructed as a multi-channel capable of diversifying substances to be measured by configuring the measurement channels 124b in multiple layers.

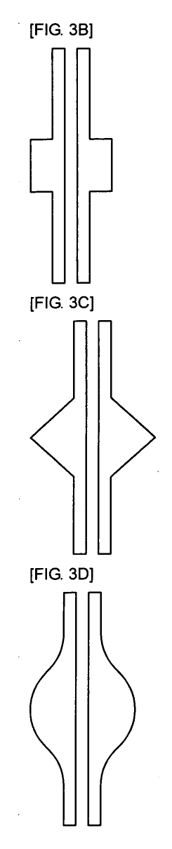

Further, the reference channel 124a and the measurement channel 124b as shown in FIG. 3 have a beam spot portion 125 at a center thereof, where the beam spot portion 125 may be formed in a shape of a trapezoid, a rectangle, a triangle, or a hemi-circle, or the like.

The refractive index of the reference channel 124a may be variously changed according to a condition change in that an outside thereof is filled with liquid or air and the measurement channel 124b to be contrasted with a resonance angle measured through the reference channel 124a may generate various responses according to a material fixed to a corresponding sample, that is, a component of a receptor, and therefore the measured result may be changed.

Accordingly, when the response on the measurement channel 124b filed with the sample occurs, the refractive index of the surface of the measurement channel 124b becomes changed and whereby the resonance angles become changed before and after the response.

When the beam emitted to the sensor chip 120 with the above-mentioned configuration through the light source is defocused and irradiated via the first lens 140, the beam split with the same incident angle is irradiated to the top portion of the reference channel 124a and the measurement channel 124b in the sensor chip 120 at the same time and the irradiated beam is reflected on the beam spot portion 125 of each of the channels 124a and 124b.

The paths of the beam reflected on each of the channels 124a and 124b of the sensor chip 120 are changed vertically by a beam splitter 150 installed on a vertical top portion of the sensor chip and the beam is traveled in parallel.

The beam of which the path is changed by the beam splitter 150 is received in the sensing unit 130, wherein the beam is converted into a parallel light while passing through a second lens 160 disposed in front of the sensing unit 130. At this time, the second lens is preferably formed of a collimator lens capable of converting the passing light into the parallel light.

Meanwhile, the sensing unit 130 is formed in an array type provided with a plurality of cells, receives the beam of which path is changed through the beam splitter 150 by being reflected from the reference channel 124a and the measurement channel 124b of the sensor chip 120 and measures a light intensity to the beam, thus knowing a change of the resonance angle after the response by each of the channels 124a and 124b.

At this time, the sensing unit 130 divides and receives the beam reflected from the reference channel 124a and the measurement channel 124b according to each cell.

It is possible to know the change of the resonance angle of the sample to be measured through the light intensity measured by the biosensor 100 having the above-mentioned technical configuration in accordance with the present invention, thereby analyzing the response of the sample to be measured.

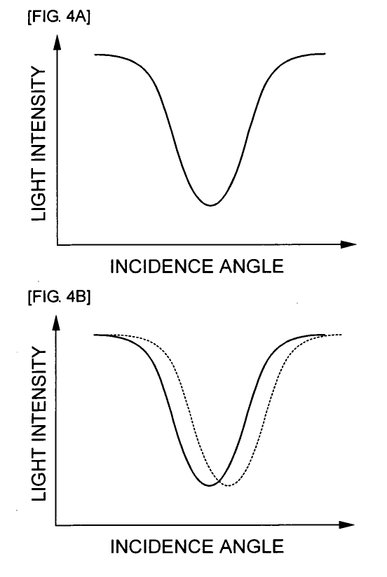

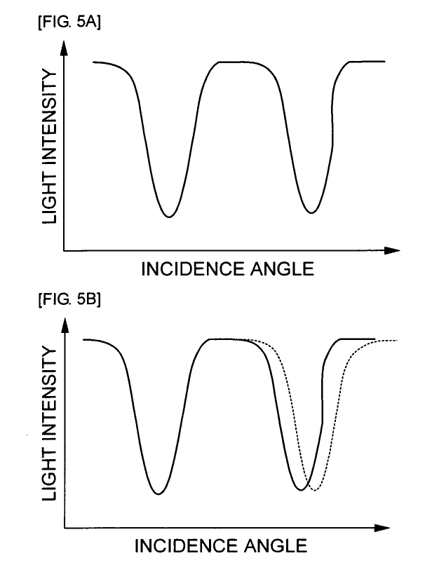

Hereinafter, the above-mentioned configuration will be set forth in more detail with reference to light intensity measuring graphs as shown in FIG. 4 and FIG. 5.

FIG. 4 is a graph for measuring the light intensity when the reference channel and the measurement channel in the biosensor have the same refractive index, wherein, as a result of measuring the light intensity according to the response of the sample after irradiating the beam through the light source 110 by a pair of reference channel 124a and measurement channel 124b having same and similar refractive index in the biosensor 100 in accordance with the present invention, before the sample responses in the measurement channel 124b, the light intensity sensed through the sensing unit by the same refractive index of the reference channel 124a and the measurement channel 124b is analyzed to be similar as shown in FIG. 4(a).

Hereinafter, it is possible to know that the resonance angle is changed since the change of the light intensity is sensed after the response in the measurement channel 124b as shown by a dotted line in FIG. 4(b).

That is, as shown in FIG. 4, as a result of measuring the light intensity through the sensing unit 130, it is possible to know that the resonance angle is changed and thus whether the sample responds in the measurement channel 124b or not.

The resonance angle may be changed according to an individual change of the light intensity of the reference channel 124a and the measurement channel 124b if there is an external element in addition to the sample response in the graph as shown in FIG. 4(b) for the sample response of the measurement channel 124b, that is, external temperature or environment change or the like to influence the reference channel 124a and the measurement channel 124b at the same time takes place.

Therefore, it is possible to measure the resonance angle exactly measured with only a change of the refractive index by the sample response in the measurement channel 124b by comparing difference of values to measure the light intensity through the reference channel 124a and the measurement channel 124b and offsetting the measurement deviation.

Further, FIG. 5 is a graph for measuring the light intensity when the reference channel 124a has a refractive index different from that of the measurement channel 124b in the biosensor in accordance with the present invention, wherein the value to measure the light intensity and the resonance angles different from each other is measured in the reference channel 124a and the measurement channel 124b through the graph in FIG. 5(a) as similar to FIG. 4 and only change of the light intensity and the resonance angle is measured in the measurement channel 124b in the sample response in the measurement channel 124b under the condition without a change of external temperature or environment, or the like.

Therefore, in FIG. 5 as similar to FIG. 4, when there is external temperature or environment change or the like to influence the reference channel 124a and the measurement channel 124b at the same time, the light intensity and the resonance angle of the reference channel 124a are also changed at the same time and it is possible to measure the variation of the light intensity and the resonance angle by the sample response in the measurement channel 124b exactly in consideration of the measurement deviation to the common variation of the light intensity in the reference channel 124a and the measurement channel 124b.

As described above, in accordance with the present invention, the multi-channel biosensor using the surface plasmon resonance has an advantage in that it is possible to know the measurement deviation to the change of the response of the measured sample contacted with the measurement channel through the light intensity and the resonance angle measured through the reference channel, thereby measuring the changed resonance angle in real time without additionally scanning the incident angle according to the change of the temperature or the external environment.

Further, it is possible to construct the sensor with a simple structure without an additional prism or a plurality of sensing units for changing the incident angle since it is possible to know the variation of the resonance angle by the external environment element through the reference channel and the measurement channel provided in the sensor chip, thus reducing the manufacturing cost thereof.

As described above, although a few preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents.

What is claimed is:

1. A multi-channel biosensor using a surface plasmon resonance comprising:
a sensor chip including a plurality of channels arranged on a top surface thereof in parallel;
a light source for vertically emitting a beam from a top portion of the sensor chip to a vertical bottom portion of the sensor chip;
a first lens for defocusing the beam emitted from the light source in the top portion of the sensor chip;
a beam splitter for splitting a reflected beam, wherein the reflected beam is obtained by reflecting the beam defocused through the first lens from each channel of the sensor chip; and
a sensing unit for receiving a parallel component of the beam splitted in the beam splitter.

2. The multi-channel biosensor according to claim 1, further comprising a second lens in front of the sensing unit for converting the reflected beam of each of the channels which is emitted toward the sensing unit into a parallel light.

3. The multi-channel biosensor according to claim 2, wherein the second lens is formed of a collimator lens.

4. The multi-channel biosensor according to claim 1, wherein the sensor chip is formed in a structure including a substrate and a dielectric layer combined with a top surface thereof and includes a metal thin film on which a reference channel and a measurement channel are arranged in parallel at a spot on which a beam is impinged between the substrate and the dielectric layer.

5. The multi-channel biosensor according to claim 4, wherein the reference channel and the measurement channel form a pair.

6. The multi-channel biosensor according to claim 4, wherein the reference channel and the measurement channel are formed with a multi-channel including one reference channel and a plurality of measurement channels.

7. The multi-channel biosensor according to claim 4, wherein a top surface of the metal thin film is formed of a convexoconcave surface.

8. The multi-channel biosensor according to claim 4, wherein the reference channel and the measurement channel are formed in a mutually symmetrical structure and a beam spot portion on which the beam is impinged is formed in a shape of a triangle to face each other.

9. The multi-channel biosensor according to claim 4, wherein the reference channel and the measurement channel are formed in a mutually symmetrical structure and a beam spot portion on which the beam is impinged is formed in a shape of a hemi-circle to face each other.

10. The multi-channel biosensor according to claim 4, wherein the reference channel and the measurement channel are formed in a mutually symmetrical structure and a beam spot portion on which the beam is impinged is formed in a shape of a tetragon to face each other.

11. The multi-channel biosensor according to claim 4, wherein the reference channel and the measurement channel are formed in a mutually symmetrical structure and a beam spot portion on which the beam is impinged is formed in a shape of a trapezoid to face each other.

12. The multi-channel biosensor according to claim 4, wherein the reference channel and the measurement channel have the same refractive index.

13. The multi-channel biosensor according to claim 4, wherein the reference channel has a refractive index different from that of the measurement channel.
